(19) United States
(12) Patent Application Publication
(10) Pub. No.: US 2019/0005528 A1
(43) Pub. Date: Jan. 3, 2019

(54) METHOD AND SYSTEM FOR AUTOMATIC OFFER REDEMPTION

(71) Applicant: GOOGLE LLC, Mountain View, CA (US)

(72) Inventors: Marc FREED-FINNEGAN, San Francisco, CA (US); Youzhong LIU, Cupertino, CA (US); Prithviraj SUBBURAJ, Santa Clara, CA (US); Stephanie Schear TILENIUS, Hillsborough, CA (US)

(21) Appl. No.: 16/125,648

(22) Filed: Sep. 7, 2018

Related U.S. Application Data
(63) Continuation of application No. 13/244,904, filed on Sep. 26, 2011.

(51) Int. Cl. G06Q 30/02; G06Q 20/40

(52) U.S. Cl. CPC G06Q 30/0215; G06Q 30/0222; G06Q 20/401

(57) ABSTRACT

Methods and systems that allow users to receive automatic discount redemptions without the use of paper coupons or loyalty cards and real time notification of such redemptions. An offer redemption module submits merchant's point of sale registration information and user's financial card account registration information to the card network partner. The card network partner notifies the offer redemption module when a request to authorize a mutual merchant/user transaction is received. The offer redemption module matches the purchase transaction with saved auto-redeemable offers and notifies the acquirer requesting redemption and sends real time notification of redemption to user when there is a match.

### TECHNICAL FIELD

The present disclosure relates generally to an intelligent coupon, and more particularly to methods and systems that allow users to receive automatic discount redemptions without the use of paper coupons or loyalty cards and real time notification of such redemptions.

### BACKGROUND

Merchants have offered coupons or rebates as incentives for purchasing particular products for some time. Traditionally, coupons are distributed in a paper format. A user redeems the coupon by physically taking it to a merchant and purchasing a product that satisfies the terms of the coupon. Such system is limited in that users are required to clip or print out paper coupons and present such coupons to the merchant to redeem the discount.

Other forms of traditional coupons included rebates for purchasing particular products, wherein after purchasing a product that satisfies the terms of the rebate offer, the user fills out and returns required forms to request the rebate. Such system is also limited in that the redemption is not automatically applied and the user is required to submit additional paperwork to receive the redemption at a later time. Also, because such rebates are usually requested and/or sent by mail, they carry a great deal of unreliability and hassle for the user.

More recently, merchants have offered electronic coupons linked to merchant loyalty cards. A user enrolls in a merchant's loyalty program and receives a loyalty card. A user then associates certain discounts to the loyalty card and redeems these discounts by presenting the loyalty card (or some form of identifying information, such as a telephone number) and the method of payment to the merchant when purchasing the discounted products. In other circumstances, discounts are automatically associated with the loyalty card and are redeemed by presenting the loyalty card (or some form of identifying information, such as a telephone number) and the method of payment to the merchant when purchasing the discounted products. However, such systems are limited in that users are required to present a loyalty card (or some form of identifying information, such as a telephone number), in addition to the method of payment, to redeem the discount.

### SUMMARY

In certain exemplary aspects, a method of establishing and maintaining an automatic offer redemption system with real time notification can include an offer redemption module that facilitates automatic, convenient and secure offer redemption with real time notification to the user. The offer redemption module contains specified registration information from a merchant and a user, and information on merchant offers for discounts. The offer redemption module can then submit the specified registration information to a card network partner who monitors the purchase transactions that belong to the registered merchants and users and send such transactions to offer redemption module for offer redemption. The offer redemption module also distributes the merchant offers through specified distribution channels. The user selects and saves one or more merchant offers that become associated with the user's financial accounts. The user then requests a purchase from the merchant using a financial account. The request is submitted to the acquirer, who in turn submits the request to the issuer via the card network partner. Once the request is authorized, the card network partner notifies the offer redemption module of the combined merchant-user transaction. If the user has a saved offer and the transaction satisfies the conditions defined by the saved offer, the offer redemption module sends a real time notification to the user of the redemption. Meanwhile, the offer redemption module notifies the card network partner and the redemption is credited to user's specified account(s). The offer redemption module then sends invoice to the merchant that includes the discount that offer redemption module has paid to the user on behalf of the merchant and any service fee that the offer redemption module charges for this service.

These and other aspects, objects, features and advantages of the exemplary embodiments will become apparent to those having ordinary skill in the art upon consideration of the following detailed description of illustrated exemplary embodiments, which include the best mode of carrying out the invention as presently presented.

### BRIEF DESCRIPTION OF THE DRAWINGS

FIG. 1 is a block diagram depicting an operating environment for automatic offer redemption with real time notification according to an exemplary embodiment.

FIG. 2 is a block flow diagram depicting a method for registering merchants and users for offer redemption according to an exemplary embodiment.

FIG. 3 is a block flow diagram depicting a method for automatic offer redemption and real time notification according to an exemplary embodiment.

FIG. 4 is a block flow diagram depicting a method for determining a registered merchant and registered user match according to an exemplary embodiment.

FIG. 5 is a block flow diagram depicting a method for offer redemption according to an exemplary embodiment.

FIG. 6 is a block flow diagram depicting a method for invoicing a merchant according to an exemplary embodiment.

### DETAILED DESCRIPTION OF EXEMPLARY EMBODIMENTS

### Overview

The exemplary embodiments provide methods and systems that enable users to utilize automatic offer redemptions for product purchases and to receive real time notification of such redemptions. The merchant registers with the offer redemption module and creates offers to be distributed by the offer redemption module. The registration information submitted by the merchant may include the acquirer's name, the merchant ID, the point of sale terminal ID, and bank account information. The offer redemption module can assist the merchant with the location and registration of the point of sale terminals. The offer redemption module sends the merchant's registration details to the card network partner. The offer redemption module may send the merchant's registration details to multiple card network partners (for example, to VISA, MasterCard, American Express and other financial card networks). The merchant specifies the details of the offer, by selecting the type of offer, the duration, the amount of the redemption, redemption conditions, and additional pertinent details when creating the offer. The merchant also provides billing information to allow offer redemption module to bill them for the discounts and service fee. The merchant can specify multiple offers to be distributed by the offer redemption module.

The user registers one or more financial card accounts with the offer redemption module and saves selected merchant offers that are then associated with all user's registered financial card accounts. The user can select and save multiple offers for the same merchant and/or multiple offers from different merchants. User can be prompted to finish registration through offer redemption module. The selected merchant offers are saved using user's digital wallet application in a data storage unit and/or in the data storage unit of the offer redemption module. The user can register more than one financial card accounts with the offer redemption module. The user also selects a financial card account or financial account to have offer redemptions credited to. The user can select the registered financial card account, a different financial card account or financial account, or a combination of financial card accounts. The offer redemption module submits user's financial account card information to the associated card network partner. For instance, if the user registers a VISA debit card with the offer redemption module, the offer redemption module submits the user's registration information for the VISA debit card to the VISA card partner. If the user registers multiple financial card accounts, the offer redemption module submits only the related user registration information to the associated card network partner. For instance, if the user registers a VISA debit card and a MasterCard credit card, the offer redemption module will submit only the VISA debit card information to the VISA card partner and only the MasterCard credit card information to the MasterCard card partner.

The user may be automatically prompted with one or more offers based on the user's registration information immediately after completing the registration process. In an alternative exemplary embodiment, the user may be prompted to register with the offer redemption module when the user clicks on or selects a redemption offer. In alternative exemplary embodiment, the user may use a smart phone application to register with the offer redemption module. In yet another alternative exemplary embodiment, the user may register with the offer redemption module through the user's digital wallet.

When a user requests to purchase a product from a merchant, the user presents a financial account card. User is not required to present a paper coupon or a loyalty card to receive the redemption. User is also not required to fill out additional paperwork after purchasing the product to receive the redemption. Merchant's point of sale terminal or online payment process engine submits a request to the acquirer for payment for the transaction. The acquirer then submits the request to authorize the transaction to the issuer through the card network partner. If funds are available, the issuer sends an authorization code to the acquirer through the card network partner and the acquirer authorizes the transaction. Meanwhile, the card network partner determines whether there is a registered merchant-registered user match and notifies the offer redemption module of the registered merchant-registered user transaction. The offer redemption module determines if user has a saved offer for transaction by retrieving the user's saved offers from the data storage unit or by interacting with user's digital wallet application. If user has a saved offer and the transaction satisfied the redemption rules defined by the saved offer, the offer redemption module sends a real time notification to the user of the redemption. The real time notification of the redemption is sent via the user's selected mode of communication (for example, SMS, e-mail, smart phone application, social network notification or other mode of communication). Meanwhile, the offer redemption module notifies the card network partner of the redemption and requests funding of the redemption. Once funded, the redemption is credited to user's specified account.

One or more aspects of the exemplary embodiments may include a computer program that embodies the functions described and illustrated herein, wherein the computer program is implemented in a computer system that comprises instructions stored in a machine-readable medium and a processor that executes the instructions. However, it should be apparent that there could be many different ways of implementing the exemplary embodiments in computer programming, and the exemplary embodiments should not be construed as limited to any one set of computer program instructions. Further, a skilled programmer would be able to write such a computer program to implement an embodiment based on the appended flow charts and associated description in the application text. Therefore, disclosure of a particular set of program code instructions is not considered necessary for an adequate understanding of how to make and use the exemplary embodiments. Moreover, any reference to an act being performed by a computer should not be construed as being performed by a single computer as the act may be performed by more than one computer. The functionality of the exemplary embodiments will be explained in more detail in the following description, read in conjunction with the figures illustrating the program flow.

### System Architecture

Turning now to the drawings, in which like numerals indicate like (but not necessarily identical) elements throughout the figures and exemplary embodiments are described in detail.

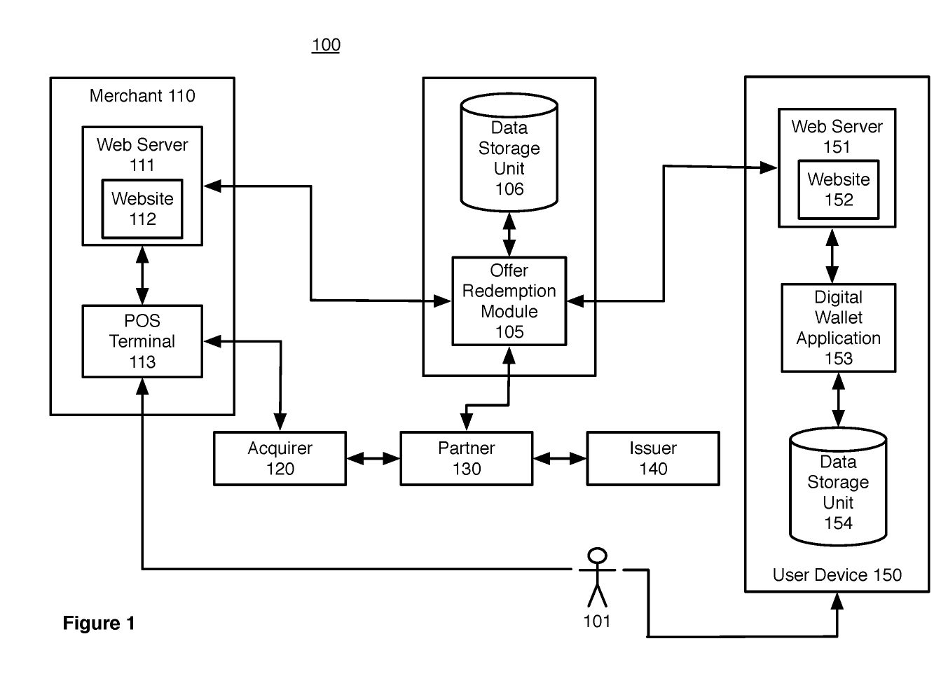

FIG. 1 is a block diagram depicting an operating environment 100 for automatic offer redemption with real time notification according to an exemplary embodiment. As depicted in FIG. 1, the exemplary operating environment 100 includes a merchant system 110, an acquirer system 120, a card network partner system 130, an issuer system 140, a user device 150 and an offer redemption module system 105 that are configured to communicate with one another via one or more networks (not shown).

Each network includes a wired or wireless telecommunication means by which network devices (including devices 105, 110, 120, 130, 140 and 150) can exchange data. For example, each network can include a local area network (“LAN”), a wide area network (“WAN”), an intranet, an Internet, a mobile telephone network, a card network or any combination thereof. Throughout this specification, it should be understood that the terms “data” and “information” are used interchangeably herein to refer to text, images, audio, video, or any other form of information that can exist in a computer-based environment.

The offer redemption module 105 includes a data storage unit 106 accessible by the offer redemption module 105. The exemplary data storage unit 106 can include one or more tangible computer-readable storage devices.

The user device 150 may be a personal computer, mobile device (for example, notebook, computer, tablet computer, netbook computer, personal digital assistant (“PDA”), video game device, GPS locator device, cellular telephone, Smartphone or other mobile device), or other appropriate technology that includes or is coupled to a web server 151 (for example, Google Chrome, Microsoft Internet Explorer, Netscape, Safari, Firefox, or other suitable application for interacting with web page files).

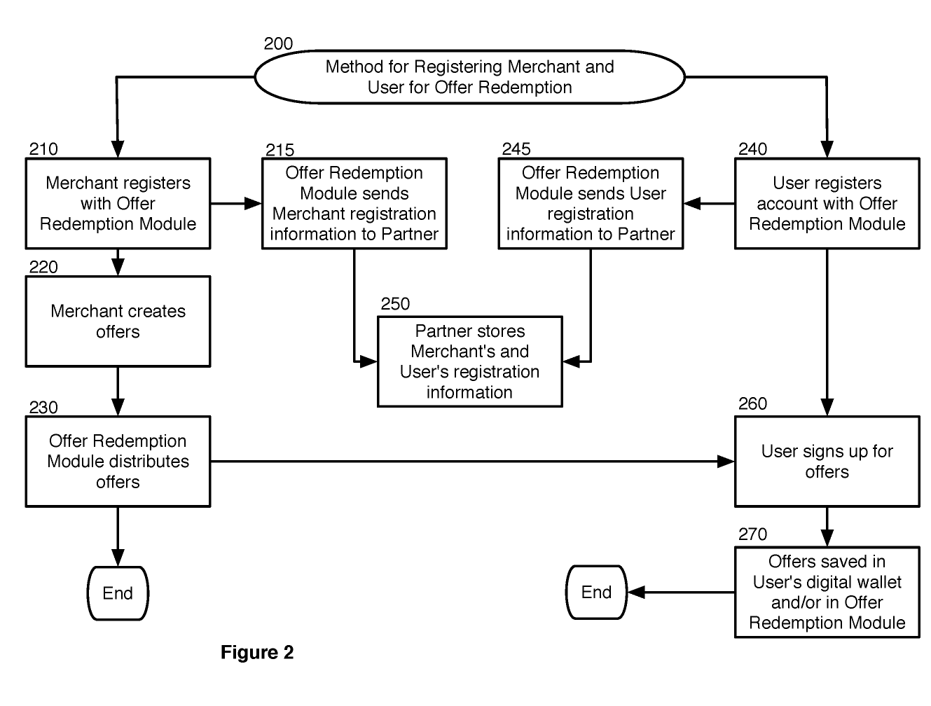

The merchant 110 can use the web server 111 to view, register, download, upload, create offers or otherwise access the offer redemption module 105 via a website 112 and a network (not illustrated). The offer redemption module 105 submits merchant's 110 registration information, including locations of all point of sale devices (“POS”) 113, to the card network partner 130. The offer redemption module 105 distributes merchant's 110 offers through selected network channels, including display on cost per mille impression (“CPM”), pay per click (“PPC”), electronic correspondence, and offers near me. The offer redemption module's 105 submission of merchant's 110 registration information and distribution of offers is described in more detail hereinafter with reference to the methods described in FIG. 2.

The user 101 can use the web server 151 to view, register, download, upload, or otherwise access the offer redemption module 105 via a website 152 and a network (not shown). The offer redemption module 105 submit user's 101 one or more registered financial card accounts, including bank account debit cards, credit cards, gift cards, or other type of financial account that can be used to make a purchase, to the card network partner 130. The user 101 can also use the web server 151 to access and select merchant's auto-redeemable offers distributed by the offer redemption module 105. The selected auto-redeemable offers are saved in the offer redemption module's 105 data storage unit 106 and/or in user's 101 digital wallet application 153. The offer redemption module's 105 submission of user's 101 registration information and selected auto-redeemable offers is described in more detail hereinafter with reference to the methods described in FIG. 2.

In certain exemplary embodiments, the network devices (including 105, 110, 120, 130, 140 and 150) include a HTML5 compliant web server. HTML5 compliant web servers include a cross-document messaging application programming interface (“API”) and a local storage API that previous HTML versions did not have. The cross-document messaging API of HTML5 compliant web servers enable documents, such as websites, to communicate with each other. For example, a first document can send a message to a second document requesting information. In response, the second document can send a message including the requested information to the first document. The local storage API of HTML5 compliant web browsers enables the web browser to store information on a client device upon which the web browser is installed or is executing, such as the user device 150. Websites can employ the local storage API to store information on a client device. Other web browsers have cross-document messaging and/or local storage capabilities also may be used in certain exemplary embodiments.

The user device 150 also includes a digital wallet application 153. The exemplary digital wallet application 153 can interact with the web server 151 or can be embodied as a companion application of the web server 151. As a companion application, the digital wallet 153 executes within the web server 151. That is, the digital wallet 153 may be an application program embedded in the web server 151. The digital wallet can also interact with the offer redemption module 105.

The user device also includes a data storage unit 154 accessible by the digital wallet 153 and the web server 151. The exemplary data storage unit 154 can include one or more tangible computer-readable storage devices. The data storage unit 154 can be stored on the user device 150 or can be logically coupled to the user device 150. For example, the data storage unit 154 can include onboard flash memory and/or one or more removable memory cards or removable flash memory.

The exemplary digital wallet 153 enables storage of one or more auto-redeemable offers selected by user 101. In an exemplary embodiment, the selected auto-redeemable offers can be maintained by the user's 101 digital wallet application 153 and stored in the data storage unit 154. In yet another embodiment, the selected auto-redeemable offers can be maintained by the offer redemption module's 105 data storage unit 106. In yet another embodiment, the selected auto-redeemable offers can be maintained by the user's 101 digital wallet application 153 and by the offer redemption module's 105 data storage unit 106.

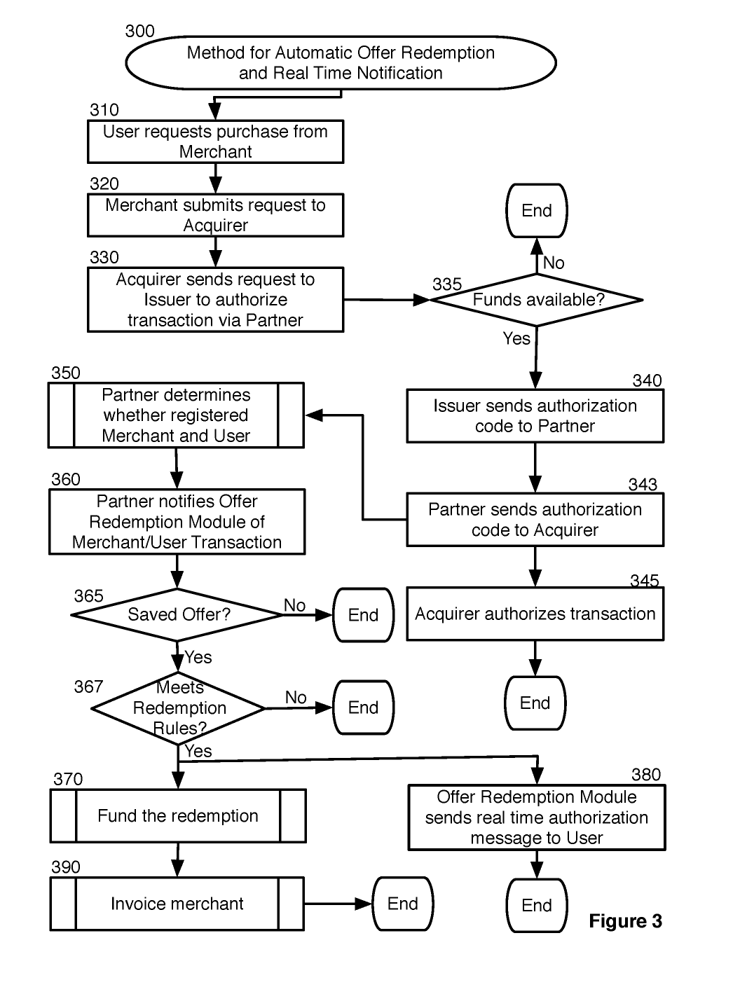

The selected auto-redeemable offers stored in the data storage unit 106 or digital wallet application 153 can be used by user 101 for purchases from merchant via the merchant's POS terminal 113, which interacts with the acquirer 120 (for example Chase PaymentTech, or other third party payment processing companies), the card network partner 130 (for example VISA, MasterCard, American Express, Discover or other card processing networks), and the issuer 140 (for example Citibank, CapitalOne, Bank of America, and other financial institutions to authorize payment). The redemption of auto-redeemable offers is described in more detail hereinafter with reference to the methods described in FIGS. 3-5.

### System Process

FIG. 2 is a block flow diagram depicting a method for registering merchants 110 and users 101 for offer redemption according to an exemplary embodiment. The method 200 is described with reference to the components illustrated in FIG. 1.

In block 210, the merchant 110 accesses the offer redemption module 105 via a website 112 and a network (not shown). In an exemplary embodiment, the merchant 110 submits registration information to the offer redemption module 105, including, but not limited to, merchant name, billing address, physical address of store(s), e-mail address, phone number, location of all POS terminals 113, name of acquirer 120, bank account information, web address and/or any other suitable information. In an exemplary embodiment, the offer redemption module 105 is able to assist merchant 110 with identifying the location of all POS terminals 113. In another embodiment, the merchant operates an on-line business without POS terminals 113.

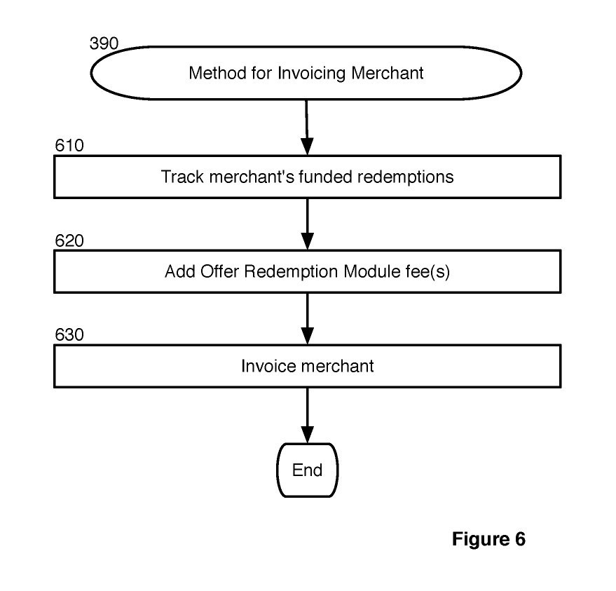

In an exemplary embodiment, the merchant 110 and the offer redemption module 105 establish a billing relationship (for example, the merchant 110 may be required to submit a deposit, the merchant 110 may be required to submit bank account information, or the merchant 110 may be billed by the offer redemption module 105 to recover the credited offer redemptions). The method for invoicing merchants is described in more detail hereinafter with reference to the methods described in FIG. 6.

The offer redemption module 105 submits merchant's 110 registration information to the card network partner 130 via a network (not shown), in block 215.

In block 240, user 101 accesses the offer redemption module 105 via a website 152 and a network (not shown). The user 101 submits registration information to the offer redemption module 105, including, but not limited to, name, address, phone number, e-mail address, information for one or more registered financial card accounts, including bank account debit cards, credit cards, or other type of account that can be used to make a purchase (for example, card type, card number, expiration date, security code, and billing address), the financial account information redemptions are to be credited to (for example, card type, card number, expiration date, security code, billing address, financial institution account, and/or financial institution account number), and method for receipt of real time authorization message (for example, text message, e-mail message, phone call, message on smart phone application, or other communication method).

In an alternative exemplary embodiment, the user 101 may be prompted to register with the offer redemption module 105 when the user 101 clicks on or selects a redemption offer. In an alternative exemplary embodiment, the user 101 may use a smart phone application to register with the offer redemption module 105. In another alternative exemplary embodiment, the user 101 may register with the offer redemption module 105 through the user's digital wallet 153.

The offer redemption module submits user's 101 registration information to a card network partner 130 via a network (not shown) in block 245.

In block 250, the card network partner 130 stores merchant's 110 registration information and user's 101 registration information received from the offer redemption module 105.

Meanwhile, in block 220, merchant 110 uses the offer redemption module 105 to create auto-redeemable offers for users 101. The offer redemption module 105 distributes merchant's auto-redeemable offers through network channels selected by merchant 110, including display on cost per mille impression (“CPM”), pay per click (“PPC”), electronic correspondence, offers near me, and other advertising methods. In an exemplary embodiment, merchant's 110 auto-redeemable offers are cost per acquisition/action (“CPA”) offers, wherein merchant pays a service fee to offer redemption module 105 for a specific desired action taken by user 101 (for example, making a purchase, a subscription, or acceptance of a trail service period). In an alternative exemplary embodiment, merchant's 110 auto-redeemable offers are pay per click (“PPC”) offers (for example, Google AdWords, Yahoo! Search Marketing, Microsoft adCenter, or other PPC providers), wherein merchant 110 pays a service fee to offer redemption module 105 for each time the offer is clicked. In yet another alternative exemplary embodiment, merchant's 110 auto-redeemable offers are cost per mille (“CPM”) or cost per thousand (“CPT”) offers, wherein merchant 110 pays a service fee to offer redemption module 105 for every 1000 page views. In another alternative exemplary embodiment, merchant's 110 auto-redeemable offers are distributed through an “offers near me” model, wherein offers are displayed in a selected search query that provides results that are physically within a set distance from user's 101 location (for example, Google Near Me Now). Merchant 110 may select multiple methods of distribution for the same auto-redeemable offer. Merchant 110 may also create multiple auto-redeemable offers to be distributed through the same or different network channels. In an exemplary embodiment, the merchant 110 is charged a service fee by the offer redemption module 105 based on the method of auto-redeemable offer distribution. In an alternative exemplary embodiment, the merchant 110 is charged a flat fee service fee by the offer redemption module 105.

In block 260, user 101 selects one or more of merchant's 110 auto-redeemable offers distributed by the offer redemption module 105 through the network channels. In an exemplary embodiment, user 101 selects the auto-redeemable offer by clicking on it and saving it in user's 101 digital wallet application 153. In an alternative exemplary embodiment, user's selected auto-redeemable offers are saved in the data storage unit 106 of the offer redemption module 105. The offer redemption module 105 associates the saved auto-redeemable offer (and the related offer redemption rules) with each of user's 101 registered financial cards. In another exemplary embodiment, a merchant 110 auto-redeemable offer may be displayed in the form of a coupon in response to user's 101 Internet search. The user 101 can download the auto-redeemable offers to user's digital wallet 153 and store the auto-redeemable offers in the data storage unit 154. In another alternative exemplary embodiment, the selected auto-redeemable offer is saved in the data storage unit 106 of the offer redemption module 105. The offer redemption module 105 associates the saved auto-redeemable offer (and the related offer redemption rules) with each of the user's 101 registered financial cards. In an alternative exemplary embodiment, the user 101 can use a smart phone application to select merchant 110 auto-redeemable offers.

The selected auto-redeemable offers are saved in the user's 101 digital wallet 123 and/or within the offer redemption module 105, at block 270.

In an exemplary embodiment, the user 101 can view saved financial card information, the saved auto-redeemable offers and/or the associated redemption rules for each auto-redeemable offer through the digital wallet 153. The user 101 may add, change or remove financial account card information using the digital wallet 153. In an exemplary embodiment, the new/changed financial account information becomes associated with the saved auto-redeemable offers previously selected and all future auto-redeemable offers selected.

In an exemplary embodiment, the saved auto-redeemable offers may be grouped (for example, as active offers, paused offers, pending offers, redeemed offers, and expired offers). Active auto-redeemable offers may include saved auto-redeemable offers that may be automatically applied to a future purchase. Paused auto-redeemable offers may include saved auto-redeemable offers that have been temporarily paused by the user so that it will no longer be automatically applied. For example, the user 101 may set redemption rules (for instance, the redemption will only be applied if the user 101 spends more than $100). Pending auto-redeemable offers may include saved offers that are in the process of being credited. Redeemed auto-redeemable offers may include saved auto-redeemable offers that have been previously applied by the user 101. Expired auto-redeemable offers may include saved auto-redeemable offers that are no longer accepted by the merchant 110.

In an exemplary embodiment, the user 101 can view purchase and redemption history information using the digital wallet 153. The user 101 may display a transaction history, a redemption history, and/or a list of total redemption savings. The user 101 may also search with the purchase and redemption history.

FIG. 3 is a block flow diagram depicting a method for automatic offer redemption and real time notification according to an exemplary embodiment. The method 300 is described with reference to the components illustrated in FIG. 1.

In block 310, user 101 requests a purchase from merchant 110. In an exemplary embodiment, user 101 swipes a financial account card or enters the financial account card information at merchant's POS terminal 113. In another embodiment, user 101 requests a purchase using merchant's 110 website and enters the financial account card information upon checkout.

Merchant's POS terminal 113 submits user's 101 request to purchase to the acquirer 120 via a network (not shown), at block 320.

In an alternative exemplary embodiment, user 101 completes an online purchase via the Internet. The user 101 can browse the merchant's 110 website for products using the web server 151 and indicate a desire to purchase one or more products. After the user 101 has indicated a desire to purchase the product(s) (for example, by actuating a “checkout” link), the merchant's 110 website can present a user interface in the form of a webpage to receive payment information from the user 101. The user 101 enters financial card information to complete the purchase. The merchant's 110 website submits a request to the acquirer 120, in block 320.

In another alternative exemplary embodiment, the digital wallet application 153 can interact with a website of the merchant 110 and with the user 101. The merchant's 110 website can detect whether the user device 150 includes a digital wallet 153 and attach to user's digital wallet 153. Once attached, the merchant's 110 website can send a purchase request message to the digital wallet 153 requesting payment information. In response to receiving a purchase request message from the merchant's 110 website, the digital wallet 153 can present the user 101 with a user interface for the user 101 to confirm the purchase using financial account information saved registered with the digital wallet 153. The merchant's 110 website submits a request to the acquirer 120, at block 320.

In block 330, the acquirer 120 submits a request to the issuer 140 to authorize payment by user's 101 swiped financial card or entered financial card information via the card network partner 130. Referring to block 335, if sufficient funds are not available the issuer 140 declines the transaction. The issuer 140 notifies the acquirer 120 of the declined transaction via the card network partner 130. The user 101 is notified of the declined transaction and does not receive the redemption.

If sufficient funds are available, the issuer 140 sends an authorization code to the card network partner 130, at block 340. The card network partner 130 then sends the authorization code to the acquirer 120, at block 343. The acquirer 120 authorizes the transaction and merchant's POS terminal 113 completes the transaction, at block 345.

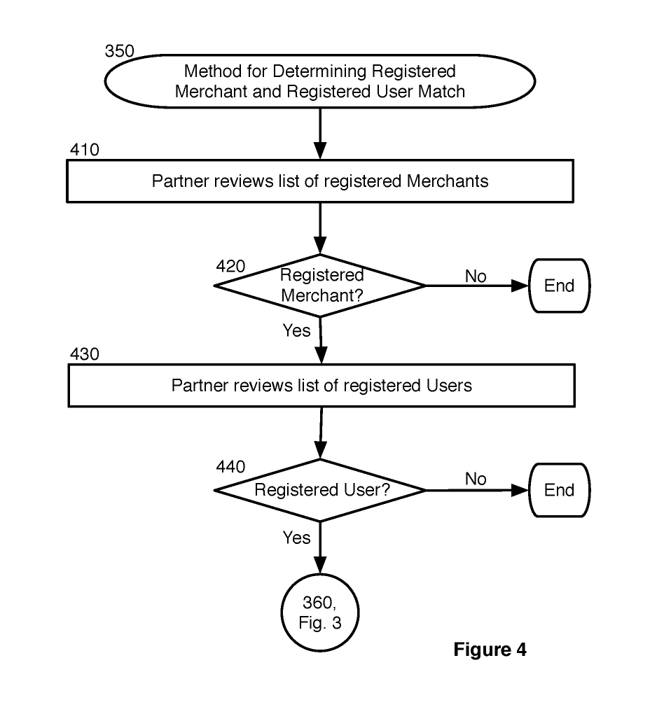

Meanwhile, at bock 350 the card network partner 130 determines whether there is a registered merchant 110 and registered user 101 match from the information stored at block 250. The determination of a registered merchant 110 and registered user 101 match is described in more detail hereinafter with reference to the methods described in FIG. 4.

If the card network partner 130 determines that there is a registered merchant 110 and registered user 101 match, the card network partner 130 notifies the offer redemption module 105 of the match, at block 360.

At block 365, the offer redemption module 105 determines whether user 101 has a saved auto-redeemable offer for the purchase. In an exemplary embodiment, the offer redemption module 105 interacts with the data storage unit 106 and retrieves user's 101 saved auto-redeemable offers. In another exemplary embodiment, the offer redemption module 105 interacts with the user's digital wallet 153 and user's 101 saved auto-redeemable offers are retrieved from the data storage device 144. If user 101 does not have a saved auto-redeemable offer for the purchase, user 101 does not receive a redemption.

If user 101 has a saved auto-redeemable offer for the purchase, the offer redemption module 105 determines whether the purchase meets the offer redemption rules, at block 367. In an exemplary embodiment, each auto-redeemable offer will have one or more rules or conditions associated with it. These rule include, but are not limited to a purchase threshold (for example, receive $10 off a single purchase of more than $50 from merchant 110), an aggregate purchase threshold (for example, receive $10 off next purchase from merchant 110 after the accumulated purchase at merchant 110 has reached $1000), a minimum number of purchases from the merchant 110 (for example, receive $10 off your tenth purchase from the merchant 110), a time restriction (for example, receive $10 off a lunch-time purchase), and/or a location restriction (for example, receive $10 off a purchase at a specified merchant 110 location. In an exemplary embodiment, these rules are set by the merchant at the time the auto-redeemable offer is created and reviewed by the offer redemption module 105 before the auto-redeemable offer is applied. In an alternative exemplary embodiment, the auto-redeemable offer is a prepaid offer and the offer redemption rules may include redemption before the expiration date.

In an exemplary embodiment, the offer redemption module 105 reviews the purchase information received from the card network partner 130 and the auto-redeemable offer rules to determine if all conditions are met. In an exemplary embodiment, this process does not require any input from the user 101.

If the purchase does not meet all the auto-redeemable offer rules, the user 101 does not receive a redemption.

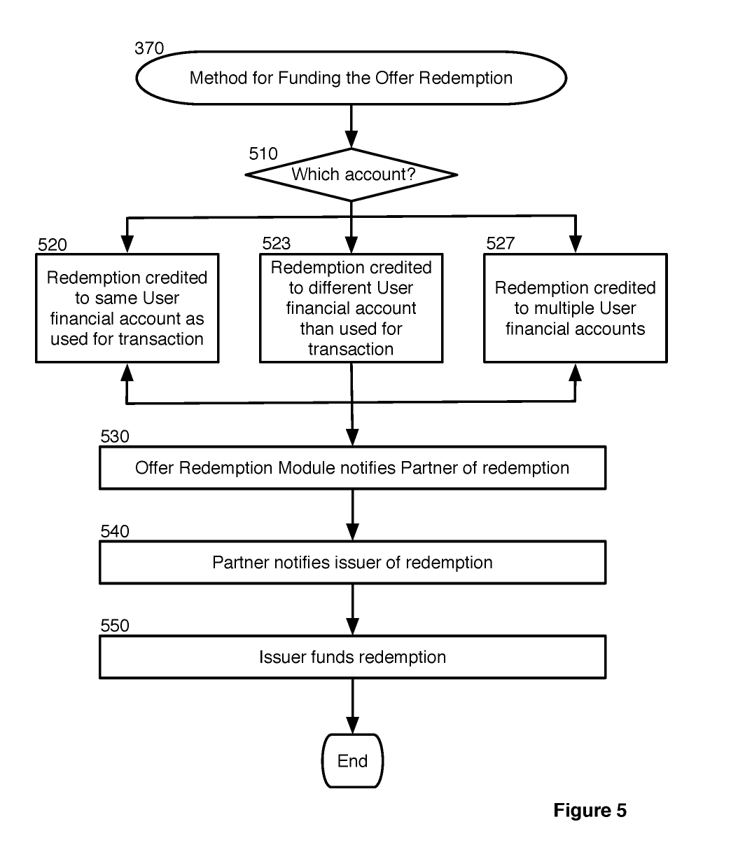

If the purchase does meet all the auto-redeemable offer rules, the user 101 receives a redemption, at block 370. The method of offer redemption is described in more detail hereinafter with referent to the methods described in FIG. 5.

Meanwhile at block 380, offer redemption module 105 sends a real time authorization message to user 101 of automatic redemption via the communication method selected by user 101 at registration. In an exemplary embodiment, the offer redemption module 105 sends a real time message to user 101 via a text message that user 101 received the redemption (for example, received x dollars off of the purchase or received x percent off of the purchase). In an alternative exemplary embodiment, the offer redemption module 105 sends a real time message to user 101 via an e-mail message that user 101 received the redemption. In yet another alternative exemplary embodiment, the offer redemption module 105 sends a real time message to user 101 via a smart phone application or social network application.

In an exemplary embodiment, the offer redemption module 105 may notify the user 101 of a close match to a saved auto-redeemable offer (for example, the user 101 spent $45, but the saved redemption offer requires user 101 to spend $50).

In block 390, the offer redemption module 105 invoices the merchant 110 for the paid redemption and service fee. The method for invoicing a merchant 110 is described in more detail hereinafter with referent to the methods described in FIG. 6.

FIG. 4 is a block flow diagram depicting a method for determining a registered merchant 110 and registered user 101 match according to an exemplary embodiment. The method 350 is described with reference to the components illustrated in FIG. 1.

If sufficient funds are available at block 335, the issuer 140 sends an authorization code to the card network partner 130 at block 340. The card network partner 130 determines whether there is a registered merchant 110 and registered user 101 match from the information stored at block 250 by first reviewing a list of registered merchants 110, at block 410. If the merchant 110 is not on the list of registered merchants, there is not a registered merchant-registered user match and the card network program does not notify the offer redemption program 105.

If the merchant 110 is on the list of registered merchants, the card network partner reviews a list of registered users 101, at block 430. If the user 101 is not on the list of registered users, there is not a registered merchant-registered user match and the card network program does not notify the offer redemption program 105.

If the user 101 is on the list of registered users, the card network 130 notifies the offer redemption module 105 of the match, at block 360.

In an alternative exemplary embodiment, the card network partner 130 creates a map or list of all possible merchant 110 and user 101 combinations.

FIG. 5 is a block flow diagram depicting a method for offer redemption according to an exemplary embodiment. The method 370 is described with reference to the components illustrated in FIG. 1.

If the offer redemption module 105 determines that user 101 has a saved auto-redeemable offer for the purchase at block 365. If the user 101 has multiple saved auto-redeemable offers that meet the offer redemption rules/conditions for a single transaction, the offer redemption module 105 may select the offer with the highest discount to be used. The offer redemption module 105 may also apply the rules created by the user 101 (for example, only redeem the saved offer if the user 101 has spent more than $100) to determine which saved offer to apply. Once the offer redemption module 105 determines the user 101 has a saved auto-redeemable offer for the transaction that meets the offer redemption rules, the redemption is funded to the user 101.

In block 510, the offer redemption module 105 determines which saved financial card account to fund the redemption to.

In an exemplary embodiment, the redemption is credited to the same financial card account as used by user 101 to make the purchase, as in block 520.

In alternative exemplary embodiment, the redemption is credited to a different financial card account or financial account than used in the transaction, as in block 523. For example, user 101 can request that all redemptions are applied to a savings account, checking account, debit card, credit card, digital wallet or other financial account.

In yet another alternative exemplary embodiment, the redemption is credited to multiple financial card accounts or financial accounts, as in block 527.

In an exemplary embodiment, the user 101 selects one or more accounts for redemptions to be funded to during the registration process. In an alternative exemplary embodiment, the user 101 creates rules that determine which account(s) redemptions will be funded to. In an exemplary embodiment, the user 101 may change or alter the selections by accessing the offer redemption module 105.

In block 530, the offer redemption module 105 notifies the card network partner 130 of the redemption. In an exemplary embodiment, the notification includes the financial account information for funding the redemption. In an exemplary embodiment, the offer redemption module 105 notifies the card network partner 130 that corresponds to the financial account to which the redemption will be funded. For example, if the user 101 selects a VISA account to fund the redemption, the offer redemption module will notify a VISA card network partner 130. The card network partner 130 notified of the redemption may or may not be the same card network partner 130 that processed the initial payment transaction for the purchase.

In block 540, the card network partner 130 notifies the issuer 140 of the redemption.

The issuer 140 then funds the redemption, in block 540. In an exemplary embodiment, the offer redemption module 105 pays for the redemption and then invoices the merchant 101 for the redemption and any fees associated with the auto-redeemable offer. The method for invoicing a merchant 110 is described in more detail hereinafter with referent to the methods described in FIG. 6.

FIG. 6 is a block flow diagram depicting a method for invoicing merchants according to an exemplary embodiment. The method 390 is described with reference to the components illustrated in FIG. 1.

In block 610, the offer redemption module 105 tracks all funded redemptions for the merchant 110. In an exemplary embodiment, the offer redemption module 105 invoices the merchant 110 at set intervals (for example, daily, weekly, monthly, etc.). In an alternative exemplary embodiment, the offer redemption module 105 invoices the merchant after each redemption is funded. In an alternative exemplary embodiment, the offer redemption module 105 invoices the merchant after the invoice amount reaches a threshold.

In block 620, the offer redemption module 105 adds any service fees for the distribution and redemption of the auto-redeemable. In an exemplary embodiment, the service fees for the distribution and redemption of the auto-redeemable offers are invoiced at the same time as the funded redemptions. In an alternative exemplary embodiment, the services fees and the redemption fees are invoiced separately.

In block 630, the offer redemption module 105 sends an invoice to the merchant 110. In an exemplary embodiment, the invoice is a debit transaction wherein the offer redemption module 105 debit funds from the merchant's 110 financial account for the amount of the invoice. In an alternative exemplary embodiment, the invoice may be subtracted from an upfront deposit made by the merchant.

### General

The exemplary methods and blocks described in the embodiments presented previously are illustrative, and, in alternative embodiments, certain blocks can be performed in a different order, in parallel with one another, omitted entirely, and/or combined between different exemplary methods, and/or certain additional blocks can be performed, without departing from the scope and spirit of the invention. Accordingly, such alternative embodiments are included in the invention described herein.

The invention can be used with computer hardware and software that performs the methods and processing functions described above. As will be appreciated by those having ordinary skill in the art, the systems, methods, and procedures described herein can be embodied in a programmable computer, computer executable software, or digital circuitry. The software can be stored on computer readable media. For example, computer readable media can include a floppy disk, RAM, ROM, hard disk, removable media, flash memory, memory stick, optical media, magneto-optical media, CD-ROM, etc. Digital circuitry can include integrated circuits, gate arrays, building block logic, field programmable gate arrays (“FPGA”), etc.

Although specific embodiments of the invention have been described above in detail, the description is merely for purposes of illustration. Various modifications of, and equivalent blocks corresponding to, the disclosed aspects of the exemplary embodiments, in addition to those described above, can be made by those having ordinary skill in the art without departing from the spirit and scope of the invention defined in the following claims, the scope of which is to be accorded the broadest interpretation so as to encompass such modifications and equivalent structures.

1-28 (canceled)

29. A computer-implemented method to automatically redeem offers during transactions without user elections, comprising:
receiving, by a computing device, a notification that a user is registered with an offer redemption system and a notification that a merchant is registered with the offer redemption system, wherein each notification is automatically generated and communicated by the offer redemption system to the computing device upon the registration of the user and the registration of the merchant;
receiving, by the computing device, a payment request from a merchant computing device for a purchase by the user from the merchant, the payment request comprising financial payment information for the user and information associated with the purchase;
communicating, by the computing device, the payment request to an issuer computing system corresponding to the financial payment information to pay for the purchase in accordance with the financial payment information;
receiving, by the computing device, a payment authorization for the request from the issuer computing system, authorizing the payment for the purchase in accordance with the financial payment information;
communicating, by the computing device, the payment authorization for the request to the merchant computing device;
based on receipt of the payment authorization by the computing device, automatically determining, by the computing device without user input, whether the user and the merchant are registered with the offer redemption system, wherein determining whether the user and the merchant are registered with the offer redemption system comprises reviewing a list of registered merchants and reviewing a list of registered users to determine that both the merchant and the user are registered with the offer redemption system;
based on determining that the user and the merchant are registered with the offer redemption system, communicating, by the computing device and to the offer redemption system, the financial payment information for the user and the information associated with the purchase;
determining, by the offer redemption system without user input, that the purchase satisfies redemption terms of an offer based on a comparison of the redemption terms of the offer with the information associated with the purchase;
based on the determination by the offer redemption system that the purchase satisfies the redemption terms of the offer, automatically generating without user input, by the offer redemption system, an offer authorization to redeem the offer, the offer authorization comprising the financial payment information for the user, an identification of the offer, and an authorization to debit funds from the offer redemption system to redeem the offer;
communicating, by the offer redemption system to the computing device, the offer authorization;
receiving, by the computing device and from the offer redemption system, the offer authorization to redeem the offer;
redeeming, by the computing device without user input, the offer by transmitting instructions to cause the issuer computing system to redeem the offer by debiting the funds from the offer redemption system and crediting the funds to a user account associated with the financial payment information for the user, wherein the offer redemption occurs automatically and simultaneously with the processing of the payment authorization by the merchant computing device; and
transmitting, by the computing device, a real-time notification to the user that the offer was redeemed.

30. The computer-implemented method of claim 29, wherein communicating the payment authorization for the payment request to the merchant computing device comprises communicating the payment authorization for the payment request to the merchant computing device via an acquirer computing device.

31. The computer-implemented method of claim 29, further comprising receiving, by the computing device, registration information of the merchant from the offer redemption system.

32. The computer-implemented method of claim 29, further comprising receiving, by the computing device, registration information of the user from the offer redemption system.

33. The computer-implemented method of claim 29, wherein redeeming the offer comprises crediting the funds to an account associated with a financial account of the user used to authorize the payment request from the merchant computing device for the purchase by the user from the merchant.

34. The computer-implemented method of claim 29, wherein redeeming the offer comprises crediting the funds to an account that is different than a financial account of the user used to authorize the payment request from the merchant computing device for the purchase by the user from the merchant.

35. The computer-implemented method of claim 34, wherein the account to which redemption of the offer is funded is managed by the offer redemption system.

36. The computer-implemented method of claim 29, wherein redeeming the offer comprises crediting the funds to multiple financial accounts of the user.

37. The computer-implemented method of claim 29, wherein the offer is one of a prepaid offer, a coupon, and a loyalty reward.

38. The computer-implemented method of claim 29, wherein the offer redemption system is a remote third-party system that manages an account of the user, the account comprising one or more registered financial payment accounts.

39. A computer-implemented method to provide automatic offer redemption and redemption alert notification without user election, comprising:
receiving, by an offer redemption computing system, a notice of a purchase transaction between a merchant and a user, the notice being received from a card network computing device, the notice comprising financial payment information for the user and at least a portion of information associated with the purchase transaction and identifying the merchant;
determining, by the offer redemption computing system without user input, that an offer is associated with an account of the user maintained by the offer redemption computing system;
determining, by the offer redemption computing system without user input, that the purchase transaction satisfies redemption terms for the offer based on the information associated with the purchase transaction and in response to determining that the offer is associated with the account of the user;
communicating, by the offer redemption computing system, an authorization to redeem the offer in connection with the purchase transaction in response to determining that the purchase transaction satisfies the redemption terms for the offer, the authorization to redeem the offer comprising the financial payment information for the user, an identification of the offer, and an authorization to debit funds from the offer redemption computing system to redeem the offer for the benefit of the user;
activating, by the offer redemption computing system, a redemption notification that notifies the user of the authorization to redeem the offer; and
implementing, by the offer redemption computing system, a transaction to collect from the merchant the funds that were debited from the offer redemption computing system.

40. The computer-implemented method of claim 39, further comprising receiving registration information to register the merchant with the offer redemption computing system.

41. The computer-implemented method of claim 39, further comprising:
distributing, by the offer redemption computing system, the offer; and
associating, by the offer redemption computing system, the offer with the account of the user maintained by the offer redemption computing device.

42. The computer-implemented method of claim 39, further comprising receiving registration information to register the user with the offer redemption computing system, the registration information being associated with the account of the user maintained by the offer redemption computing system.

43. The computer-implemented method of claim 39, wherein the account of the user maintained by the offer redemption computing system is a digital wallet.

44. The computer-implemented method of claim 39, further comprising crediting, by the offer redemption computing system, the funds to redeem the offer to the account of the user maintained by the offer redemption computing system.

45. The computer-implemented method of claim 39, wherein the offer is one of a prepaid offer, a coupon, and a loyalty reward.

46. The computer-implemented method of claim 39, wherein the notice being received from the card network computing device indicates that the purchase transaction between the merchant and the user was authorized by an issuer computing system, the issuer computing system corresponding to a financial payment account to pay for the purchase in accordance with the financial payment information.

47. A computer program product, comprising:
a non-transitory computer-readable medium having computer-executable program code embodied therein that when executed by one or more computing devices cause the one or more computing devices to automatically redeem offers without user elections, the computer-executable program code comprising:
computer-executable program code to receive a payment request for a purchase by a user from a merchant, the payment request comprising financial payment information for the user and information associated with the purchase;
computer-executable program code to submit the payment request to an issuer computing system corresponding to the financial payment information to pay for the purchase in accordance with the financial payment information;
computer-executable program code to receive a payment authorization for the payment request from the issuer computing system, authorizing the payment for the purchase in accordance with the financial payment information;
computer-executable program code to forward the payment authorization for the payment request to a merchant computing device;
computer-executable program code to determine without user input that the user and the merchant are registered with an offer redemption computing system in response to receiving the payment authorization for the payment request from the issuer computing system authorizing the payment for the purchase in accordance with the financial payment information; and
computer-executable program code to communicate, to the offer redemption computing system, the payment request in response to determining that the user and the merchant are registered with an offer redemption computing system, the offer redemption computing system without user input authorizing redemption of an offer in connection with the payment request and activating a redemption notification that notifies the user of the offer redemption authorization and a credit of funds to redeem the offer to the user.

48. The computer program product of claim 47, further comprising:
computer-executable program code to receive registration information of the merchant from the offer redemption computing system; and
computer-executable program code to receive registration information of the user from the offer redemption computing system, wherein the computer-executable program code to determine that the user and the merchant are registered with the offer redemption computing system comprises computer-executable program code to review a list of registered merchants and to review a list of registered users to determine that both the merchant and the user are registered with the offer redemption computing system.

49. The computer program product of claim 47, further comprising:
computer-executable program code to receive an offer authorization from the offer redemption computing system to redeem an offer in connection with the payment request, the offer authorization comprising an identification of the offer and an authorization to charge funds to the offer redemption computing system to redeem the offer, wherein the offer comprises redemption terms that are satisfied by the purchase; and
computer-executable program code to implement the charge of funds to the offer redemption computing system to redeem the offer and a credit of the funds to redeem the offer to the user.

50. The computer program product of claim 47, wherein implementing the credit of the funds to redeem the offer to the user comprises instructing the issuer computing system to credit an account of the user with the funds to redeem the offer.

51. The computer program product of claim 47, wherein the redemption of the offer is funded to an account associated with the financial payment information of the user.

52. The computer program product of claim 47, wherein the redemption of the offer is funded to an account that is different than an account associated with the financial payment information of the user.

53. The computer program product of claim 50, wherein the account to which the offer is funded is managed by the offer redemption computing system.

54. The computer program product of claim 47, wherein the redemption of the offer is funded to multiple financial accounts of the user.
